(19) United States
(12) Patent Application Publication
(10) Pub. No.: US 2025/0175207 A1
(43) Pub. Date: May 29, 2025

(54) RADIO FREQUENCY CARRIER AGGREGATION SUPPORT ARCHITECTURE

(71) Applicant: Skyworks Solutions, Inc., Irvine, CA (US)

(72) Inventor: John Chi-Shuen Leung, Foothill Ranch, CA (US)

(21) Appl. No.: 18/960,828

(22) Filed: Nov. 26, 2024

Related U.S. Application Data
(60) Provisional application No. 63/604,107, filed on Nov. 29, 2023.
(60) Provisional application No. 63/604,102, filed on Nov. 29, 2023.

(51) Int. Cl. H04B 1/40

(52) U.S. Cl. CPC H04B 1/40

(57) ABSTRACT

Aspects of this disclosure relate to front-end modules with improved transmit power added efficiency and receive sensitivity. The front-end modules can include a multiplexing unit that includes two triplexers connected to isolated antenna ports and configured to provide carrier aggregation via main and diversity paths. Related methods, radio frequency systems, radio frequency modules, and wireless communication devices are also disclosed.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of this disclosure relate to multiplexers arranged to filter signals, such as radio frequency signals.

### Description of Related Technology

Radio frequency (RF) communication systems can be used for transmitting and/or receiving signals of a wide range of frequencies.

For example, an RF communication system can be used to wirelessly communicate RF signals in a frequency range from about 30 kHz to about 300 GHz, such as in the range of about 410 megahertz (MHz) to about 7.125 gigahertz (GHz) for Fifth Generation (5G) cellular communications in Frequency Range 1 (FR1).

RF communication systems can include without limitation mobile phones, tablets, base stations, network access points, customer-premises equipment (CPE), laptops, and wearable electronics.

With an ever-increasing demand for throughput to serve streaming and other applications, there is a need for RF systems that can handle higher bandwidths while constraining costs and without sacrificing performance.

### SUMMARY

In some aspects, the techniques described herein relate to a radio frequency front-end configured for carrier aggregated wireless communication, the radio frequency front-end including: a first multiplexer having at least first, second, and third filters, the first filter having a passband of an uplink channel of a first band, the second filter having a passband of a downlink channel of the first band, and the third filter having a passband of a downlink channel of a second band; and a second multiplexer having at least fourth, fifth, and sixth filters, the fourth filter having a passband of an uplink channel of the second band, the fifth filter having a passband of the downlink channel of the second band, and the sixth filter having a passband of the downlink channel of the first band; and an antenna switch connected to a first multiplexed port of the first multiplexer and a second multiplexed port of the second multiplexer to selectively connect the first multiplexed port to at least a first antenna and selectively connect the second multiplexed port to at least a second antenna.

In some aspects, the techniques described herein relate to a radio frequency front-end wherein a radio frequency isolation between the first and second antennas is larger than 15 dB for the first and second bands.

In some aspects, the techniques described herein relate to a radio frequency front-end wherein the first, second, and third filters are configured to attenuate frequencies outside of their respective passbands by at least 40 dB.

In some aspects, the techniques described herein relate to a radio frequency front-end wherein at least one of the first, second, and third filters is configured to attenuate frequencies outside of its respective passband by less than 50 dB.

In some aspects, the techniques described herein relate to a radio frequency front-end wherein the fourth, fifth, and sixth filters are configured to attenuate frequencies outside of their respective passbands by at least 40 dB.

In some aspects, the techniques described herein relate to a radio frequency front-end wherein at least one of the fourth, fifth, and sixth filters is configured to attenuate frequencies outside of its respective passband by less than 50 dB.

In some aspects, the techniques described herein relate to a radio frequency front-end wherein the first band is LTE band 20 and the second band is LTE band 8 (B8).

In some aspects, the techniques described herein relate to a radio frequency front-end wherein the first multiplexed port includes a connection between an output of the first filter, an input to the second, and an input to the third filter, and the second multiplexed port includes a connection between an output of the fourth filter, an input to the fifth filter, and an input to the sixth filter.

In some aspects, the techniques described herein relate to a radio frequency front-end wherein the first, second, and third filters are ganged together on a common substrate, and the fourth, fifth, and sixth filters are ganged together on a common substrate.

In some aspects, the techniques described herein relate to a radio frequency front-end further including a transmit power amplifier and a band select switch configured to selectively connect an output of the transmit power amplifier to either of the first filter or the fourth filter.

In some aspects, the techniques described herein relate to a radio frequency front-end further including first, second, third and fourth receive amplifiers, inputs of the first, second, third, and fourth receive amplifiers respectively connected to outputs of the second, third, fifth, and sixth filters.

In some aspects, the techniques described herein relate to a radio frequency front-end wherein the front-end is configured to implement downlink carrier aggregation using four downlink signals output by the second, third, fifth, and sixth filters.

In some aspects, the techniques described herein relate to a mobile device including: at least first and second antennas; a first multiplexer having at least first, second, and third filters, the first filter having a passband of an uplink channel of a first band, the second filter having a passband of a downlink channel of the first band, and the third filter having a passband of a downlink channel of a second band; a second multiplexer having at least fourth, fifth, and sixth filters, the fourth filter having a passband of an uplink channel of the second band, the fifth filter having a passband of the downlink channel of the second band, and the sixth filter having a passband of the downlink channel of the first band; and an antenna switch connected to a first multiplexed port of the first multiplexer and a second multiplexed port of the second multiplexer to selectively connect the first multiplexed port to at least the first antenna and selectively connect the second multiplexed port to at least the second antenna.

In some aspects, the techniques described herein relate to a mobile device wherein the first, second, and third filters are ganged together on a common substrate, and the fourth, fifth, and sixth filters are ganged together on a common substrate.

In some aspects, the techniques described herein relate to a mobile device wherein a radio frequency isolation between the first and second antennas is larger than 15 dB for the first and second bands.

In some aspects, the techniques described herein relate to a mobile device wherein at least one of the first, second, and third filters is configured to attenuate frequencies outside of its respective passband by less than 50 dB.

In some aspects, the techniques described herein relate to a mobile device wherein the fourth, fifth, and sixth filters are configured to attenuate frequencies outside of their respective passbands by at least 40 dB.

In some aspects, the techniques described herein relate to a mobile device wherein at least one of the fourth, fifth, and sixth filters is configured to attenuate frequencies outside of their respective passbands by less than 50 dB.

In some aspects, the techniques described herein relate to a mobile device wherein the first multiplexed port includes a connection between an output of the first filter, an input to the second, and an input to the third filter, and the second multiplexed port includes a connection between an output of the fourth filter, an input to the fifth filter, and an input to the sixth filter.

In some aspects, the techniques described herein relate to a frequency multiplexing device configured for carrier aggregated wireless communication, the frequency multiplexing device including: a first multiplexer including at least first, second, and third filters, the first filter having a passband of an uplink channel of a first band, the second filter having a passband of a downlink channel of the first band, and the third filter having a passband of a downlink channel of a second band, the first multiplexer further including a first multiplexed port having a connection between an output of the first filter, an input to the second filter, and an input to the third filter; and a second multiplexer including at least fourth, fifth, and sixth filters, the fourth filter having a passband of an uplink channel of the second band, the fifth filter having a passband of the downlink channel of the second band, and the sixth filter having a passband of the downlink channel of the first band, the second multiplexer further including a second multiplexed port having a connection between an output of the fourth filter, an input to the fifth filter, and an input to the sixth filter.

In some aspects, the techniques described herein relate to a frequency multiplexing device wherein the first, second, and third filters are ganged together on a common substrate, and the fourth, fifth, and sixth filters are ganged together on a common substrate.

In some aspects, the techniques described herein relate to a frequency multiplexing device wherein a radio frequency isolation between the first and second antennas is larger than 15 dB for the first and second bands.

In some aspects, the techniques described herein relate to a frequency multiplexing device wherein at least one of the first, second, and third filters is configured to attenuate frequencies outside of its respective passband by less than 50 dB.

In some aspects, the techniques described herein relate to a frequency multiplexing device wherein the fourth, fifth, and sixth filters are configured to attenuate frequencies outside of their respective passbands by at least 40 dB.

In some aspects, the techniques described herein relate to a frequency multiplexing device wherein at least one of the fourth, fifth, and sixth filters is configured to attenuate frequencies outside of their respective passbands by less than 50 dB.

In some aspects, the techniques described herein relate to a frequency multiplexing device wherein the first multiplexed port includes a connection between an output of the first filter, an input to the second, and an input to the third filter, and the second multiplexed port includes a connection between an output of the fourth filter, an input to the fifth filter, and an input to the sixth filter.

In some aspects, the techniques described herein relate to a radio frequency front end module configured for carrier aggregation, the radio frequency front end module including: a multiplexing device including a first frequency multiplexer implemented on a first substrate and configured to connect, to a primary antenna, a first frequency selective transmit path and at least two frequency selective primary receive paths, the multiplexing device further including a second frequency multiplexer implemented on a second substrate and configured to connect, to a diversity antenna, a second frequency selective transmit path and at least two frequency selective diversity receive paths; one or more transmit amplifiers coupled to the multiplexing device to provide amplified transmit signals corresponding to the first and second frequency selective transmit paths, respectively; and a set of receive amplifiers coupled to the multiplexing device to amplify receive signals corresponding to the at least two frequency selective primary receive paths and the at least two frequency selective diversity receive paths.

In some aspects, the techniques described herein relate to a radio frequency front end module wherein the at least two frequency selective primary receive paths include first and second frequency selective receive paths configured to pass signals having a first downlink frequency and signals having a second downlink frequency, respectively, and the at least two frequency selective diversity receive paths include third and fourth frequency selective receive paths configured to pass signals having the first downlink frequency and signals having the second downlink frequency, respectively.

In some aspects, the techniques described herein relate to a radio frequency front end module wherein the first frequency selective receive path is configured to attenuate signals having the second downlink frequency by at least 40 dB.

In some aspects, the techniques described herein relate to a radio frequency front end module wherein the first frequency selective receive path is configured to attenuate the signals having the second downlink frequency by less than 50 dB.

In some aspects, the techniques described herein relate to a radio frequency front end module wherein the first and second frequency multiplexers provide frequency division duplex communication with receive carrier aggregation for two communication bands, and at least one of the first and the second frequency multiplexers are configured to provide an insertion loss at least 0.2 dB lower than a duplexer loaded by another duplexer for providing frequency division duplex communication with carrier aggregation for the two communication bands.

In some aspects, the techniques described herein relate to a radio frequency front end module wherein a radio frequency isolation between the first and second frequency selective transmit paths is larger than 15 dB, at least for transmitting signals in uplink portions of the two communication bands.

In some aspects, the techniques described herein relate to a radio frequency front end module wherein the two communication bands are band 20 (B20) and band 8 (B8).

In some aspects, the techniques described herein relate to a radio frequency front end module further including an antenna switch, a first module port configured for connection to the primary antenna, and a second module port configured for connection to the diversity antenna, the antenna switch connected between the multiplexing device and the first and second module ports.

In some aspects, the techniques described herein relate to a radio frequency front end module further including a band select switch connected between the one or more transmit amplifiers and the multiplexing device.

In some aspects, the techniques described herein relate to a radio frequency front end module wherein the first frequency multiplexer is contained in a first integrated circuit package, the second frequency multiplexer is contained in a second integrated circuit package, and the radio frequency front end module is contained within a module package.

In some aspects, the techniques described herein relate to a radio frequency front end module wherein the first multiplexing device includes three bandpass filters corresponding to the first frequency selective transmit path and the at least two frequency selective primary receive paths, respectively, and the second multiplexing device includes three bandpass filters corresponding to the second frequency selective transmit path and the at least two frequency selective diversity receive paths, respectively.

In some aspects, the techniques described herein relate to a frequency multiplexing device configured to support carrier aggregation, the frequency multiplexing device including: a first frequency multiplexer implemented on a first substrate and configured to connect, to a primary antenna, a first frequency selective transmit path and at least two frequency selective primary receive paths; and a second frequency multiplexer implemented on a second substrate and configured to connect, to a diversity antenna, a second frequency selective transmit path and at least two frequency selective diversity receive paths.

In some aspects, the techniques described herein relate to a frequency multiplexing device wherein the at least two frequency selective primary receive paths include first and second frequency selective receive paths configured to pass signals having a first downlink frequency and signals having a second downlink frequency, respectively, and the at least two frequency selective diversity receive paths include third and fourth frequency selective receive paths configured to pass signals having the first downlink frequency and signals having the second downlink frequency, respectively.

In some aspects, the techniques described herein relate to a frequency multiplexing device wherein the first frequency selective receive path is configured to attenuate signals having the second downlink frequency by at least 40 dB.

In some aspects, the techniques described herein relate to a frequency multiplexing device wherein the first frequency selective receive path is configured to attenuate the signals having the second downlink frequency by less than 50 dB.

In some aspects, the techniques described herein relate to a frequency multiplexing device wherein the first and second frequency multiplexers provide frequency division duplex communication with receive carrier aggregation for two communication bands, and at least one of the first and the second frequency multiplexers are configured to provide an insertion loss at least 0.2 dB lower than a duplexer loaded by another duplexer for providing frequency division duplex communication with carrier aggregation for the two communication bands.

In some aspects, the techniques described herein relate to a frequency multiplexing device wherein a radio frequency isolation between the first and second frequency selective transmit paths is larger than 15 dB, at least for transmitting signals in uplink portions of the two communication bands.

In some aspects, the techniques described herein relate to a frequency multiplexing device wherein the two communication bands are band 20 (B20) and band 8 (B8).

In some aspects, the techniques described herein relate to a radio frequency multiplexing device wherein the first frequency multiplexer is contained in a first integrated circuit package and the second frequency multiplexer is contained in a second integrated circuit package.

In some aspects, the techniques described herein relate to a mobile device configured for carrier aggregation including: a primary antenna; a diversity antenna; and a multiplexing device including a first frequency multiplexer implemented on a first substrate and configured to connect, to the primary antenna, a first frequency selective transmit path and at least two frequency selective primary receive paths, the multiplexing device further including a second frequency multiplexer implemented on a second substrate and configured to connect, to the diversity antenna, a second frequency selective transmit path and at least two frequency selective diversity receive paths.

In some aspects, the techniques described herein relate to a mobile device wherein the multiplexing device connects to the primary antenna and the diversity antenna via an antenna switch.

In some aspects, the techniques described herein relate to a radio frequency front-end configured to allow carrier aggregated wireless communication using multiple downlink and uplink carrier frequencies, the radio frequency front-end including: a frequency multiplexing unit configured to provide a first frequency selective path from a carrier selection switch to a first antenna port and a second frequency selective path from the carrier selection switch to a second antenna port electrically isolated from the first antenna port, the first frequency selective path configured to pass signals having a first uplink carrier frequency and reject signals having a first downlink carrier frequency and a second downlink carrier frequency, the second frequency selective path configured to pass signals having a second uplink carrier frequency and reject signals having the first downlink carrier frequency and the second downlink carrier frequency, the first frequency selective path provided through a first frequency multiplexer and the second frequency selective path provided through a second frequency multiplexer electrically isolated from the first multiplexer.

In some aspects, the techniques described herein relate to a radio frequency front-end wherein the first and the seconds frequency multiplexers are fabricated on separate chips.

In some aspects, the techniques described herein relate to a radio frequency front-end wherein a radio frequency isolation between the first and second antenna ports is larger than 15 dB for carrier frequencies used to establish aggregated wireless communication.

In some aspects, the techniques described herein relate to a radio frequency front-end wherein the first frequency multiplexer further provides: a third frequency selective path from the first antenna port to a low noise amplification device for passing signals having the first downlink carrier frequency; and a fourth frequency selective path from the first antenna port to the low noise amplification device for passing signals having second downlink carrier frequency.

In some aspects, the techniques described herein relate to a radio frequency front-end wherein the third, and fourth frequency selective paths are configured to pass signals having frequencies within respective transmission bandwidths and attenuate the signals having frequencies out of the respective transmission bandwidths by at least 40 dB.

In some aspects, the techniques described herein relate to a radio frequency front-end wherein at least one of the third, and fourth frequency selective paths is configured to attenuate the signals having frequencies out of the respective passband by less than 50 dB.

In some aspects, the techniques described herein relate to a radio frequency front-end wherein at least one of the first, second, third and fourth frequency selective paths is configured to attenuate the signals having frequencies within the respective passband by at least 0.2 dB less than a frequency selective path of a duplexer supporting the respective passband and ganged by another duplexer.

In some aspects, the techniques described herein relate to a radio frequency front-end wherein the second frequency multiplexer provides: a fifth frequency selective path from the second antenna port a low noise amplification device for passing signals having the first downlink carrier frequency; and a sixth frequency selective path from the second antenna port to the low noise amplification device for passing signals having second downlink carrier frequency.

In some aspects, the techniques described herein relate to radio frequency front-end wherein at least one the fifth and sixth frequency selective paths is configured to attenuate the signals having frequencies out of respective transmission bandwidths by at least 40 dB.

In some aspects, the techniques described herein relate to a radio frequency front-end wherein at least one of the fifth and sixth frequency selective paths is configured to attenuate the signals having frequencies out of the respective passband by less than 50 dB.

In some aspects, the techniques described herein relate to a radio frequency front-end wherein at least one of the first, second, fifth and sixth frequency selective paths is configured to attenuate the signals having frequencies within the respective passband by at least 0.2 dB less than a frequency selective path of a duplexer supporting the respective passband and ganged by another duplexer.

In some aspects, the techniques described herein relate to a frequency multiplexing device having two input ports, two transmit/receive ports, and four output ports, the frequency multiplexing device including: a first triplexer having a first simplex port connected to a first input port, second and third simplex ports connected to first and second output ports, and a multiplex port connected to a first transmit/receive port; and a second triplexer having a fourth simplex port connected to a second input port, fifth and sixth simplex ports connected to third and fourth output ports, and a multiplex port connected to a second transmit/receive port, the first and second transmit/receive ports being electrically isolated.

In some aspects, the techniques described herein relate to a frequency multiplexing device wherein the first and second frequency triplexers are fabricated on separate chips.

In some aspects, the techniques described herein relate to a frequency multiplexing device wherein the first and second frequency triplexers are electrically isolated.

In some aspects, the techniques described herein relate to a frequency multiplexing device wherein the first and second frequency triplexers each include three individual bandpass filters.

In some aspects, the techniques described herein relate to a frequency multiplexing device wherein at least one bandpass filter of the three individual bandpass filter includes a surface acoustic wave filter.

In some aspects, the techniques described herein relate to a frequency multiplexing device wherein the first frequency triplexer provides: a first frequency selective path from the first input port to the first transmit/receive port for passing signals having a first uplink carrier frequency. a second frequency selective path from the first transmit/receive port to the first output port for passing signals having a first downlink carrier frequency: and a third frequency selective path from the first transmit/receive port to the second output port for passing signals having a second downlink carrier frequency.

In some aspects, the techniques described herein relate to a frequency multiplexing device wherein the first, second, and third frequency selective paths are configured to pass signals having frequencies within respective passband and attenuate the signals having frequencies out of the respective passband by at least 40 dB.

In some aspects, the techniques described herein relate to a frequency multiplexing device wherein at least one of the first, second, and third frequency selective paths is configured to attenuate the signals having frequencies out of the respective passband by less than 50 dB.

In some aspects, the techniques described herein relate to a frequency multiplexing device wherein at least one of the first, second, and third frequency selective paths is configured to attenuate the signals having frequencies within the respective passband by at least 0.2 dB less than a frequency selective path of a duplexer supporting the respective passband and ganged by another duplexer.

In some aspects, the techniques described herein relate to a frequency multiplexing device wherein the second frequency triplexer provides: a fourth frequency selective path from the second input port to the second transmit/receive port for passing signals having a second uplink carrier frequency. a fifth frequency selective path from the second transmit/receive port to the third output port for passing signals having a first downlink carrier frequency: and a sixth frequency selective path from the second transmit/receive port to the fourth output port for passing signals having a second downlink carrier frequency.

In some aspects, the techniques described herein relate to a frequency multiplexing device wherein the fourth, fifth, and sixth frequency selective paths is configured to attenuate the signals having frequencies out of respective transmission bandwidths by at least 40 dB.

In some aspects, the techniques described herein relate to a frequency multiplexing device wherein at least one of the fourth, fifth, and sixth frequency selective paths is configured to attenuate the signals having frequencies out of the respective passband by less than 50 dB.

In some aspects, the techniques described herein relate to a frequency multiplexing device wherein at least one of the fourth, fifth, and sixth frequency selective paths is configured to attenuate the signals having frequencies within the respective passband by at least 0.2 dB less than a frequency selective path of a duplexer supporting the respective passband and ganged by another duplexer.

In some aspects, the techniques described herein relate to a frequency multiplexing device wherein the first frequency triplexer includes: a first bandpass filter configured to pass signals having a first uplink carrier frequency and reject signals having first and second downlink carrier frequencies. a second bandpass filter configured to pass signals having a first downlink carrier frequency and reject signals having the first uplink carrier frequency and signals having the second downlink carrier frequency; and a third bandpass filter configured to pass signals having a second downlink carrier frequency and reject signals having the first uplink carrier frequency and signals having the first downlink carrier frequency.

In some aspects, the techniques described herein relate to a frequency multiplexing device wherein the first, second, and third bandpass filters are configured to attenuate the signals having frequencies out of respective transmission bandwidths by at least 40 dB.

In some aspects, the techniques described herein relate to a frequency multiplexing device wherein at least one of the first, second, and third bandpass filters is configured to attenuate the signals having frequencies out of the respective passband by less than 50 dB.

In some aspects, the techniques described herein relate to a frequency multiplexing device wherein the second frequency triplexer provides: a fourth frequency selective path from the second input port to the second transmit/receive port for passing signals having a second uplink carrier frequency. a fifth frequency selective path from the second transmit/receive port to the third output port for passing signals having a first downlink carrier frequency: and a sixth frequency selective path from the second transmit/receive port to the fourth output port for passing signals having a second downlink carrier frequency.

In some aspects, the techniques described herein relate to a frequency multiplexing device wherein the fourth, fifth, and sixth frequency selective paths is configured to attenuate the signals having frequencies out of a respective passband by at least 40 dB.

In some aspects, the techniques described herein relate to a frequency multiplexing device wherein at least one of the first, second, and third frequency selective paths is configured to attenuate the signals having frequencies out of the respective passband by less than 50 dB.

In some aspects, the techniques described herein relate to a frequency multiplexing device wherein the first uplink carrier frequency and the second downlink carrier frequency include frequencies within band 20 (B20) and band 8 (B8).

### BRIEF DESCRIPTION OF THE DRAWINGS

Embodiments of this disclosure will now be described, by way of non-limiting example, with reference to the accompanying drawings.

FIG. 1 is a schematic diagram of one example of a communication network.

FIG. 2A is a schematic diagram of one example of a communication link that uses carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3 illustrates an example of a mobile device.

FIG. 4A is a schematic block diagram of a front-end module design.

FIG. 4B is a schematic block diagram of an example embodiment of the front-end module shown in FIG. 4A.

FIG. 4C shows the loading loss for a duplexer plotted against the number of filters or filter portions that are connected to the multiplex port of the duplexer.

FIG. 5 is a schematic block diagram of a front-end module in accordance with certain embodiments described herein.

### DETAILED DESCRIPTION

### Overview

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IoT), Vehicle-to-Everything (V2X), and High-Power User Equipment (HPUE).

3GPP introduced Phase 1 of fifth generation (5G) technology in Release 15, and is currently in the process of developing Phase 2 of 5G technology in Release 16. Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

### Communication Network

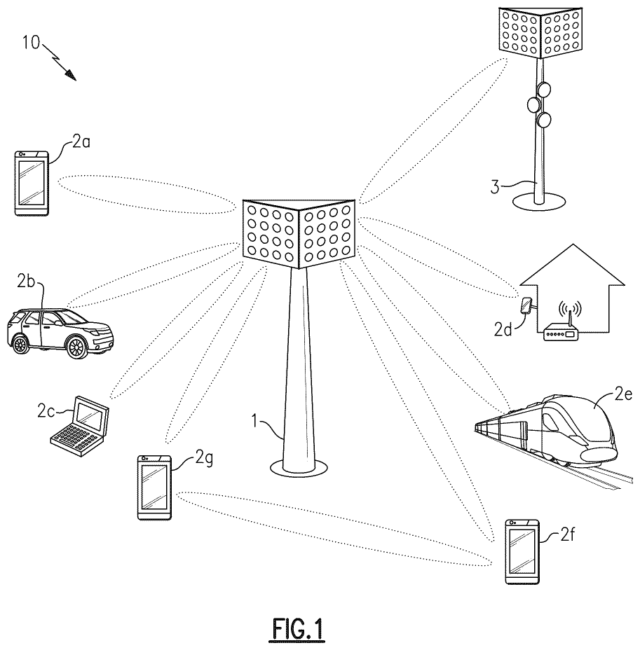

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul (for instance, as between mobile device 2g and mobile device 2f).

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

A peak data rate of a communication link (for instance, between a base station and a user device) depends on a variety of factors. For example, peak data rate can be affected by channel bandwidth, modulation order, a number of component carriers, and/or a number of antennas used for communications.

For instance, in certain implementations, a data rate of a communication link can be about equal to M*B*log₂(1+S/N), where M is the number of communication channels, B is the channel bandwidth, and S/N is the signal-to-noise ratio (SNR).

Accordingly, data rate of a communication link can be increased by increasing the number of communication channels (for instance, transmitting and receiving using multiple antennas), using wider bandwidth (for instance, by aggregating carriers), and/or improving SNR (for instance, by increasing transmit power and/or improving receiver sensitivity).

5G NR communication systems can employ a wide variety of techniques for enhancing data rate and/or communication performance.

### Carrier Aggregation

Improvement on network data rates was possible under the 3GPP LTE-Advanced by introducing the concept of carrier aggregation (CA). Under CA, a user equipment (UE) is simultaneously linked to more than one channel and thereby more resource blocks (RBs) are assigned to a single user. While CA applied to the downlink (DL-CA) bands enhances data transfer from the network to the UE, CA on the uplink (UL-CA) bands improves data transfer from the UE to the network. Typically, DL data traffic is often higher than the UL traffic; therefore, implementations of CA have focused on DL-CA.

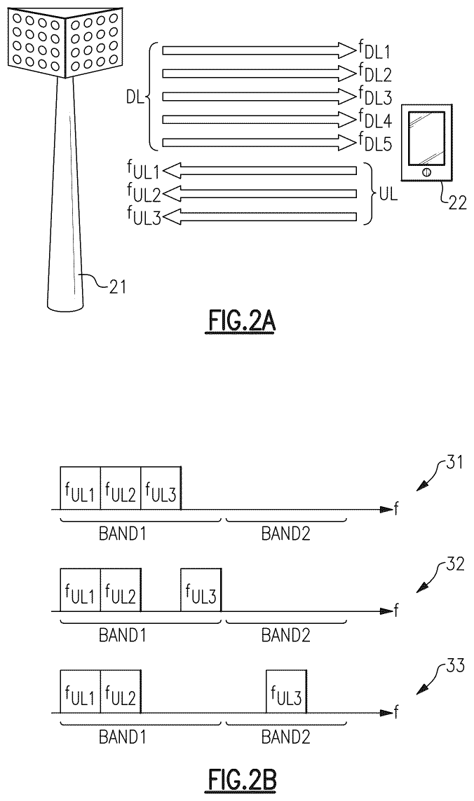

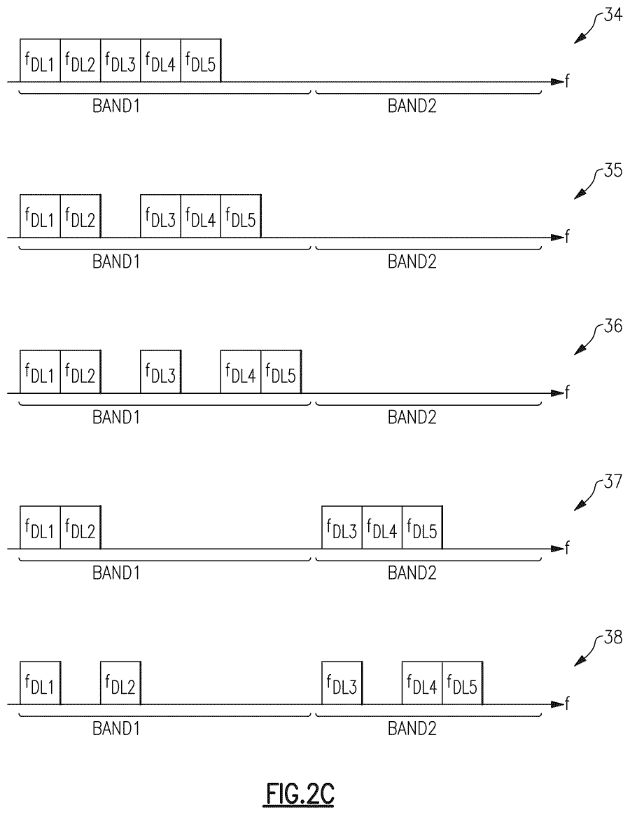

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations. Carrier aggregation can present challenges for designing frequency multiplexing device with high out-of-band rejection (e.g., to isolate the frequency carriers) and low loss transmission. The frequency multiplexing arrangements disclosed herein can be implemented to support carrier aggregation applications.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and secondary cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as Wi-Fi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid Wi-Fi users and/or to coexist with Wi-Fi users. Enhanced license assisted access (eLAA) refers to an evolution of LAA that aggregates licensed and unlicensed spectrum for both downlink and uplink.

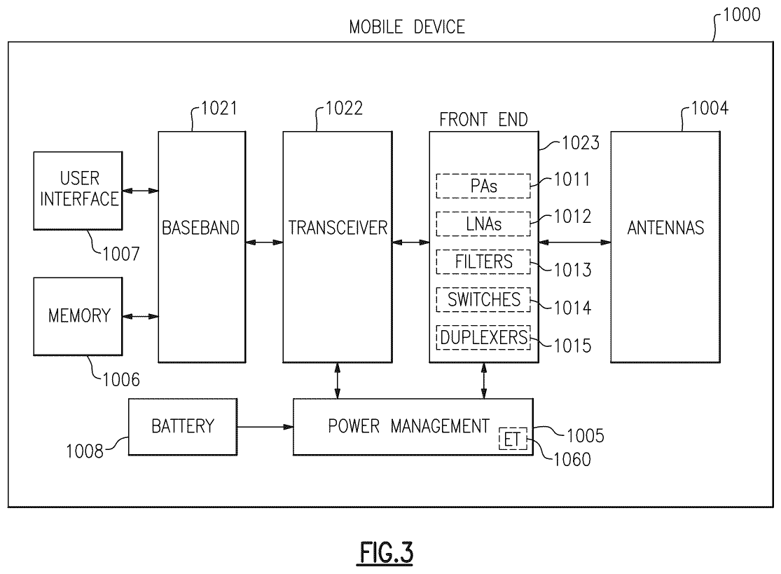

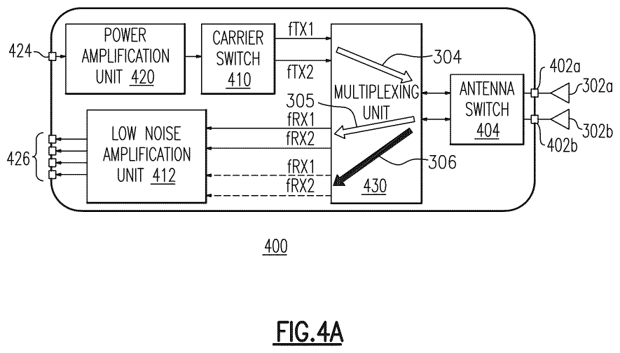

FIG. 3 is a schematic diagram of one example of a mobile device 1000. The mobile device 1000 includes a baseband system 1021, a transceiver 1022, a front-end system 1023, antennas 1024, a power management system 1005, a memory 1006, a user interface 1007, and a battery 1008.

The mobile device 1000 can be used communicate using a wide variety of communications technologies, including, but not limited to, 2G, 3G, 4G (including LTE, LTE-Advanced, and LTE-Advanced Pro), 5G, WLAN (for instance, Wi-Fi), WPAN (for instance, Bluetooth and ZigBee), WMAN (for instance, WiMax), and/or GPS technologies.

The transceiver 1022 generates RF signals for transmission and processes incoming RF signals received from the antennas 1024. It will be understood that various functionalities associated with the transmission and receiving of RF signals can be achieved by one or more components that are collectively represented in FIG. 1 as the transceiver 1022. In one example, separate components (for instance, separate circuits or dies) can be provided for handling certain types of RF signals.

The front-end system 1023 aids is conditioning signals transmitted to and/or received from the antennas 1024. In the illustrated embodiment, the front-end system 1023 includes power amplifiers (PAS) 1011, low noise amplifiers (LNAs) 1012, filters 1013, switches 1014, and multiplexers 1015 (e.g., duplexers, triplexers). However, other implementations are possible.

For example, the front-end system 1023 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 1000 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band and/or in different bands.

The antennas 1024 can include antennas used for a wide variety of types of communications. For example, the antennas 1024 can include antennas associated transmitting and/or receiving signals associated with a wide variety of frequencies and communications standards.

In certain implementations, the antennas 1024 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 1000 can operate with beamforming in certain implementations. For example, the front-end system 1023 can include phase shifters having variable phase controlled by the transceiver 1022. Additionally, the phase shifters are controlled to provide beam formation and directivity for transmission and/or reception of signals using the antennas 1024. For example, in the context of signal transmission, the phases of the transmit signals provided to the antennas 1024 are controlled such that radiated signals from the antennas 1024 combine using constructive and destructive interference to generate an aggregate transmit signal exhibiting beam-like qualities with more signal strength propagating in a given direction. In the context of signal reception, the phases are controlled such that more signal energy is received when the signal is arriving to the antennas 1024 from a particular direction. In certain implementations, the antennas 1024 include one or more arrays of antenna elements to enhance beamforming.

The baseband system 1021 is coupled to the user interface 1007 to facilitate processing of various user input and output (I/O), such as voice and data. The baseband system 1021 provides the transceiver 1022 with digital representations of transmit signals, which the transceiver 1022 processes to generate RF signals for transmission. The baseband system 1021 also processes digital representations of received signals provided by the transceiver 1022. As shown in FIG. 3, the baseband system 1021 is coupled to the memory 1006 of facilitate operation of the mobile device 1000.

The memory 1006 can be used for a wide variety of purposes, such as storing data and/or instructions to facilitate the operation of the mobile device 1000 and/or to provide storage of user information.

The power management system 1005 provides a number of power management functions of the mobile device 1000. The power management system 1005 of FIG. 3 includes an envelope tracker 1060. As shown in FIG. 3, the power management system 1005 receives a battery voltage form the battery 1008. The battery 1008 can be any suitable battery for use in the mobile device 1000, including, for example, a lithium-ion battery.

The mobile device 1000 of FIG. 1 illustrates one example of an RF system that can include multiplexers 1015 implemented in accordance with one or more features of the present disclosure. For example, the front-end system 1023 may include multiplexers and demultiplexers configured to provide uplink paths and downlink paths and channels to enable carrier aggregated wireless communication. However, the teachings herein are applicable to RF systems implemented in a wide variety of ways.

In some embodiments, the mobile device 1000 may be connected to a wireless network that uses carrier aggregation (CA) to increase the bit rate supported by a communication channel. For example, the wireless network may use a 3GPP LTE-advanced carrier aggregation scheme. In these embodiments, the front-end system 1023 may include a multiplexer to generate an uplink transmit signal (Tx) by combining component carriers and a demultiplexer to separate component carriers from a received downlink signal (Rx). In some examples, the multiplexer and the demultiplexer may each comprise a plurality of bandpass filters with center frequencies near or substantially equal to frequencies of the component carriers. Such BP filters must provide high level of isolation between different carrier components not only within a single frequency division duplexed (FDD) band but also across the different FDD LTE bands used in CA.

The configurations and filters used for designing multiplexers/demultiplexer should take into the requirements of a CA based mobile device, for example, low in-band loss, high inter-band isolation, high level of OOB rejection, small size, and low intermodulation distortion. One of the most commonly used configurations for multiplexing/demultiplexing is the manifold-coupled configuration (e.g., star junction configuration) that support low insertion loss and enables a high level of miniaturization. In a star-junction configuration all component carriers are combined at a common junction and therefore resulting in a more even power distribution. The star junction may be used to combine any number of component carriers independent of their bandwidth and frequency separation.

In order to implement the carrier aggregation schemes described above, the communication devices and systems (e.g., wireless receivers) should be equipped with circuits that can combine component carriers before transmission (e.g., to an antenna) and/or separate them from a received signal. In some cases, this can be achieved using frequency multiplexers and frequency demultiplexers composed of bandpass filters having passbands (e.g., non-overlapping passbands) near the frequencies of the corresponding component carriers. For example, when CA is applied to a down-link (DL-CA), a frequency division duplexed (FDD) mobile device may transmit at one frequency while simultaneously receive at a different frequency. Such mobile device may use duplexers or multiplexers where a transmitting filter passes the transmitted data, while providing sufficient rejection (typically 60 dB) in the receive band to prevent de-sensing the receiver. On the other side, the receive filter passes the received data, while providing sufficient rejection in the transmit band to avoid the transmitted power from blocking the receiver. Bandpass filter may be used for separating carrier components in various carrier aggregation scenarios (e.g., those shown in FIG. 2C). In particular for separating a component carrier from component carriers distributed over a wide frequency range, a bandpass filter should provide sufficient out-of-band (OOB) rejection over a wide out-of-band frequency range to avoid crosstalk.

In some embodiments, bandpass filters used in a multiplexer need to present high out-of-band (OOB) rejection at all bands that are being multiplexed while maintaining low in-band loss. It is, however, challenging to obtain a broad OOB rejection to cover all bands of interest while preserving minimum in-band loss. There is always a trade-off between a filter's in-band performance (e.g., bandwidth and in-band insertion loss) and its OOB rejection level (also referred to as rejection floor) as well as the filter's bandwidth and the filter OOB rejection. The self-isolation and cross-isolation between the multiplexed filters depend on the rejection floor provided by each filter at the other bands' frequency of interest and are important parameters to consider when designing multiplexers that support carrier aggregation (CA).

Front-end module: general design

As mentioned above, in order to support efficient carrier aggregation (CA) based wireless communication, the multiplexers 1015 of the front-end system 1023 may provide frequency selective RF paths for signals having multiple carrier frequencies (e.g., downlink and uplink carrier frequencies) to be simultaneously transmitted to and received from the antennas 1024.

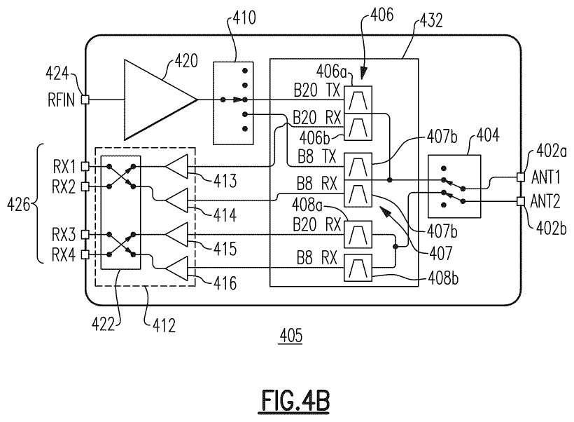

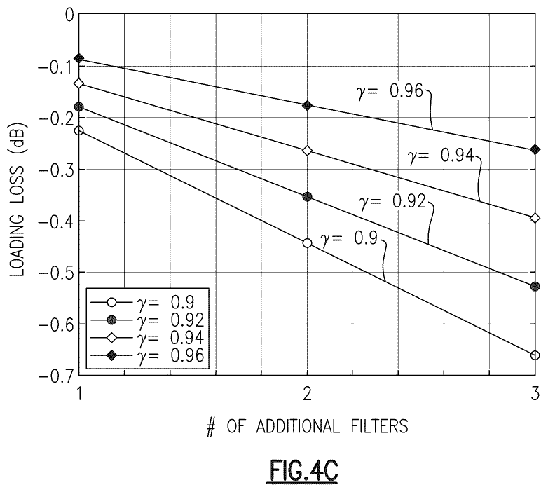

FIG. 4A is a schematic diagram of a front-end module 400 configured for CA-based wireless communication according to an embodiment. In some cases, the front-end module 400 may be configured to establish an uplink channel using two or more uplink carrier frequencies, and two or more down link channels using two or more downlink carrier frequencies. In some cases, a CA uplink channel 304 may comprise multiple RF transmit paths. In some cases, a CA downlink channel 305, 306 may comprise multiple RF receive paths.

In some wireless communication links, user demand for downlink capacity can be higher than that of uplink capacity (e.g., for multimedia content streaming). As such in some cases, the front-end module 400 may be configured to establish at least two downlink channels functioning in parallel: a main downlink channel 305 and a diversity downlink channel 306.

In some implementations, within the front-end module 400, the uplink channel 304 comprises a separate transmit path for each uplink carrier frequency and each downlink channel 305 or 306 comprises a separate receive path for each downlink carrier frequency. In one embodiment, the front-end module 400 may comprise a power amplification unit 420 (e.g., a transistor-based power amplifier), a carrier switch 410, a multiplexing unit 430, an antenna switch 404, two antenna ports 402a, 402b, and a low noise amplification unit 412. In some examples, a first antenna port 402a can be electrically connected to a first antenna 302a and a second antenna port 402b can be connected to a second antenna 302b. In some embodiments, the multiplexing unit 430 can include at least two input ports connected to the carrier switch 410, at least four output ports connected to the low noise amplification unit, and at least two transmit/receive (TR) ports connected to the antenna switch 404. In some examples, the power amplification unit 420 receives a transmit signal via a transmit signal port 424, amplifies the received transmit signal and provides the amplified transmit signal to the multiplexing unit 430 via the carrier switch 410. The carrier switch 410 is configured to provide the amplified transmit signal to the multiplexing unit 430 based on an uplink carrier frequency of the amplified signal. For example, the carrier switch 410 may provide the amplified signal to an input port of the multiplexing unit 430 may pass the signals having frequencies within a particular bandwidth around the uplink carrier frequency and attenuate the signals having frequencies outside the bandwidth (e.g., by more than 20 dB, 30 dB, 40 dB, or 60 dB). The multiplexing unit 430 may be configured to provide the amplified signal to the antenna port 402a or 402b from one of its transmit/receive (TR) ports and via the antenna switch 404. The multiplexing unit 430 may be further configured to provide a receive signal received from the antenna port 402a or 402b, via one of its TR ports, to the low noise amplification unit 412. In some examples, the antenna switch 404 may direct receive signals to one or more TR ports of the multiplexing unit 430 configured to pass signals having frequencies within a particular bandwidth around a downlink carrier frequency of the receive signal and attenuate the signals having frequencies outside the bandwidth (e.g., by more than 20 dB, 30 dB, 40 dB, or 60 dB). In some examples, transmit signals having different uplink carrier frequencies (e.g., fTX1 and fTX2) may be provided to the same or different antenna ports 402a, 402b via a different transmit path for each uplink carrier frequency. In some embodiments, a receive signal having a downlink carrier frequency may be received from both antennas 302a and 302b via both antenna ports 402a, 402b and pass through the multiplexing unit 430 via two distinct paths: a main receive path and a diversity receive path. As such, in the example shown, receive signals having two downlink frequencies fTRX1 and fRX2, may be directed from both antennas ports 402a, 402b, to the low noise amplifier unit 412 via four distinct receive paths: two main receive paths and two diversity receive paths resulting in an enhanced downlink speed compared to the uplink speed.

In some implementations, the multiplexing unit 430 may be configured to provide an uplink channel 304 comprising two frequency selective RF transmit paths for each of the two uplink carrier frequencies (e.g., fTX1 and fTX2), a main downlink channel 305 comprising a frequency selective RF receive path for each of two down link carrier frequency (e.g., fRX1 and fRX2), and a diversity downlink channel 306 comprising a frequency selective RF receive path for each of the two down link carrier frequencies (e.g., fRX1 and fRX2).

In some embodiments, a frequency selective RF path (e.g., transmit or receive path) may comprise a low loss frequency selective RF path that is configured to allow low loss RF transmission at frequencies within a passband around a carrier frequency (e.g., a carrier frequency of a carrier aggregated wireless communication link) while attenuating signals having frequencies outside of the passband (e.g., other carrier frequencies of the carrier aggregated wireless communication link). In some examples, a frequency selective RF path provides the minimal insertion loss within the corresponding passband and attenuates the noise outside of its passband to the desired level.

In some embodiments, a frequency selective RF path may comprise at least one bandpass RF filter configured to provide, at least partially, the frequency selectivity of the path. In some cases, the bandpass filter may attenuate signals having frequencies within its passband by less than 2 dB, less than 1 dB, less than 0.5 dB or smaller values, and attenuate signals having frequencies outside of its passband by than 20 dB, more than 30 dB, more than 40 dB, more than 50 dB, more than 60 dB, or larger values. In various implementations, the passband of an RF path within the multiplexing unit 430 or the passband of the corresponding band pass filter can be from 1 MHZ to 10 MHZ, from 10 MHz to 100 MHz, from 100 MHz to 500 MHZ or any ranges formed by these values.

In some implementations, a carrier aggregated wireless communication link may be established using four carrier frequencies: two carrier frequencies for the uplink channel (e.g., uplink channel 304) and two carrier frequencies for each downlink channel (e.g., the main down link channel 305 and the diversity downlink channel 306). In some cases, one of the uplink carrier frequency and downlink carrier frequency can be within the band 8 (B8) (e.g., uplink 880-915 MHz and downlink 925-960 MHz and the other within band 20 (B20) (e.g., uplink 832-862 MHz and downlink 791-821 MHz). In various implementations, B8 and B20 can be associated with 4G long-term evolution (LTE) technology or 5G New Radio (NR) technology. In some cases, one of the uplink carrier frequency and downlink carrier frequency can be within the band 5 (B5) and the other within band 12 (B12), band 13 (B13), or band 28 (B28). In some cases, one of the uplink carrier frequency and downlink carrier frequency can be within the band 8 (B8) and the other within band 28 (B28). In some cases, one of the uplink carrier frequency and downlink carrier frequency can be within the band 20 (B20) and the other within band 28 (B28). Other frequency bands can be paired to establish a CA wireless link.

In some cases, a frequency selective RF path and/or the corresponding bandpass filter may be configured to transmit signals having one of the four carrier frequencies and attenuate or reject the signals having at least one of the other carrier frequencies. In some cases, the spectrum of a signal having a carrier frequency may comprise the carrier frequency and frequency components within a bandwidth around the carrier frequency.

In some cases, the number of uplink carrier frequencies can be equal to (symmetric CA) or different (asymmetric CA) from a number of downlink carrier frequencies. Accordingly, a number of transmit paths within an uplink channel can be equal to or different from a number of receive paths within a downlink channel (e.g., main or diversity receive channel).

In various, implementations, the multiplexing unit 430 may comprise one or more frequency multiplexers (e.g., frequency duplexers or triplexers) configured to support the low loss transmit and receive RF paths (e.g., main and diversity receive paths). The frequency multiplexers (also referred to as multiplexers) may be configured to provide the transmit and receive paths between the input ports and the RT ports and receive paths between RT ports and the output ports of the multiplexing unit 430. In some embodiments, separate multiplexers may be used to establish the transmit channel and the diversity receive channel within the multiplexing unit 430. In some embodiments, such as the embodiments disclosed herein, at least one multiplexer may be shared between an uplink channel (e.g., uplink channel 304) and a diversity downlink channel (e.g., diversity downlink channel 306). Advantageously, in some such embodiments (where a multiplexer is shared between the uplink channel and the diversity downlink channel), the multiplexers of the multiplexing unit 430 may not load each other, and the channels can be implemented using a smaller number of multiplexers. As a result, in these embodiments, the insertion loss of each channel may decrease, and the overall sensitivity and power added efficiency of the front-end module 400 may increase.

In some cases, the multiplexer may comprise one or more bandpass frequency filters (also referred to as filter portions) each configured to receive an input signal from a different simplex port of a plurality of simplex ports and an interconnection that combines the filtered signals transmitted through the individual bandpass filters and outputs the resulting combined signal via a multiplex port. In some cases, when the multiplexer is used as a demultiplexer a signal received via the multiplex port is distributed among the bandpass filters and each filtered signal transmitted through the respective bandpass frequency filter is output from a different simplex port.

In some embodiments, various filter designs may be used in a multiplexer/demultiplexer usable in communication systems and devices functioning based on CA scheme. In some embodiments, a filter of the multiplexer/demultiplexer can be a bandpass filter. In some cases, the bandpass filter can be a resonant filter comprising one or more RF resonators or configured to provide a frequency passband having a bandwidth around the corresponding carrier frequency. In some cases, the bandwidth of the filter can be inversely proportional to a number of resonators and the output band rejection (attenuation) and in band loss of the filter can be directly proportional to a number of resonators. In some cases, the RF resonators used in the bandpass filter may comprise planar conductive resonators, bulk dielectric resonators, surface acoustic wave (SAW) resonators, or bulk acoustic wave (BAW) resonators.

In some cases, a multiplexer may be fabricated (e.g., monolithically) on a single chip. For example, a multiplexer may comprise SAW filters formed on a common substrate. In some cases, two multiplexers may be fabricated on a common substrate but can be electrically isolated. In some cases, the RF isolation between two individual multiplexers fabricated on the same substrates can be greater than 10 dB, greater than 15 dB, greater than 20 dB or greater values.

In some cases, multiplex ports of two or more multiplexers may be connected to a single port RT port of the multiplexing unit 430. In some such cases, the impedance of the multiplex port for the out of band frequencies of the corresponding multiplexers may decrease compared to that of a single multiplexer and/or compared to an open impedance (e.g., due to loading effect). In some cases, the impedance of the multiplex port for the out of band frequencies of the corresponding multiplexers may decrease proportional to the magnitude of out-of-band gamma (the reflection or S11 coefficient) of the individual multiplexers connected to the corresponding multiplex port. As such it may be advantageous to design the multiplexing unit 430 such that the multiplexers and/or filters are electrically isolated and do not load each other.

In some implementations, the front-end module 400 may be characterized based on power added efficiency (PAE) of the transmitting portion of the front-end module 400 (or the corresponding mobile device) and sensitivity (or signal-to-noise ratio) of the receiving portion of the front-end module 400 (or the corresponding mobile device). The PAE can be affected by the insertion loss of the uplink channel 304 of the multiplexing unit 430 and the sensitivity can be affected by the insertion loss of the downlink channels 305, 306 of the multiplexing unit 430. As a result, the design of the multiplexing unit 430 (e.g., the number and type of multiplexer used and their interconnections) can have significant impact on the PAE and sensitivity of the multiplexing unit 430.

### Front-End Modules: Dedicated Duplexers for Main Paths

FIG. 4B is a schematic diagram of front-end module 405, an implementation of the front-end module 400, having dedicated duplexers 406, 407 for first transmit and first main receive paths, and second transmit and second main receive paths, which are frequency selective RF paths for B20 and B8 FDD frequency bands in the illustrated embodiment, respectively. The front-end module 405 also includes first and second bandpass filters 408a, 408b for the first and second diversity receive paths respectively. The TX and RX paths provided by the first and second duplexers 406, 407 can be referred to as “primary” paths, whereas the RX paths provided by the first and second bandpass filters 408a, 408b can be referred to as “diversity” paths.

The preamplification unit 412 of the front-end module 405 comprises four preamplifiers 413, 414, 415, 416 (e.g., low noise amplifiers), and an output switch 422. The two duplexers 406, 407 are configured to provide transmit paths from the carrier switch 410 to the first antenna port 402a (via the antenna switch 404) and main receive paths from the first antenna port 402a to two preamplifiers 413, 414, of the preamplifier unit 412. The two bandpass filters 408a, 408b are configured to provide diversity receive paths from the second antenna to the other two preamplifiers 415, 416, of the preamplifier unit 412, via the antenna switch 404.

A duplexer can include a first simplex port, a second simplex port, and a multiplex port. The duplexer provides a frequency selective RF path between each simplex port and the multiplex port at frequencies within a bandwidth around an uplink carrier frequency or a main downlink carrier frequency and prevents signals having out of band frequencies from being coupled to the frequency selective RF path (e.g., by strongly attenuating such signals that may be received via the other simplex port, or the multiplex port).

In the example shown, the first simplex port of the first duplexer 406 is connected to a first output port of the carrier switch 410, the second simplex port of the first duplexer 406 is connected to the input of the first preamplifier 413, and the multiplex port of the first duplexer 406 is connected to the first antenna port 402a via the antenna switch 404. The first duplexer 406 can include a transmit filter portion 406a (e.g., a bandpass filter) configured to transmit a signal having a first uplink carrier frequency fTX1 (e.g., within B20 TX frequency band) from a first output port of the carrier switch 410 to the first antenna port 402a and prevent frequency content outside of a passband around the first uplink carrier frequency (fTX1) from passing through the transmit filter portion 406a of the first duplexer 406 from the first simplex port to the multiplex port. For example, the transmit filter portion 406a of the first duplexer 406 may at least prevent signals having the first downlink carrier frequency fRX1 (e.g., within B20 RX frequency band) and signals having the second down link carrier frequency fRX2 (e.g., within B8 RX frequency band) from being coupled to its first simplex port. The first duplexer 406 also includes a receive filter portion 406b (e.g., a bandpass filter) configured to pass signals having the first downlink carrier frequency fRX1 (e.g., within B20 RX frequency band) from the multiplex port of the first duplexer 406 to the second simplex port of the first duplexer 406 and reject signal content outside of the corresponding passband (e.g., B20 RX frequency band or band therein). For example, the receive filter portion 406b of the first duplexer 406 may at least prevent signals having the first uplink carrier frequency fTX1 (e.g., within B20 TX frequency band) and signals having the second downlink carrier frequency fRX2 (e.g., within B8 RX frequency band) from being coupled to its first simplex port.

In the example shown, the first simplex port of the second duplexer 407 is connected to a second output port of the carrier switch 410, the second simplex port of the second duplexer 407 is connected to the input of the second preamplifier 414, and the multiplex port of the first duplexer 407 is connected to the first antenna port 402a via the antenna switch 404.

In some examples, the second duplexer 407 can include a transmit filter portion 407a (e.g., a bandpass filter) configured to pass a signal having a second uplink carrier frequency fTX2 (e.g., B8 TX frequency band or a band therein) from a second output port of the carrier switch 410, to the first antenna port 402a, and prevent signals having frequency content outside of a passband around the second uplink carrier frequency fTX2 (e.g., outside of B8 TX frequency band) from passing through the transmit filter portion 407a of the second duplexer 407 from the first simplex port to the multiplex port. For example, the transmit filter portion 407a of the second duplexer 407 may at least prevent signals having the first downlink carrier frequency fRX1 (e.g., within B20 RX frequency band) and signals having the second down link carrier frequency fRX2 (e.g., within B8 RX frequency band) from being coupled to its first simplex port.

The second duplexer 407 also includes a receive filter portion 407b (e.g., a bandpass filter) configured to pass signals having the second downlink carrier frequency fRX2 (e.g., within B8 RX frequency band) from the multiplex port of the second duplexer 407 to the second simplex port of the second duplexer 407 and reject frequency content outside of the corresponding passband (e.g., B8 RX frequency band or a band therein). For example, the receive filter portion 407b of the second duplexer 407 may at least prevent signals having the second uplink carrier frequency fTX2 (e.g., within B8 TX frequency band) and signals having the first downlink carrier frequency fRX1 (e.g., within B20 RX frequency band) from being coupled to its first simplex port.

In the implementation of FIG. 4B, the multiplex ports of the first and the second duplexers 406, 407, are electrically connected to each other to provide a single port of the multiplexing unit 430 that is connected to the first antenna port 402a via the antenna switch 404. In some embodiments, the coupled connection between the first and second duplexers 406, 407 is selectively connected to either the first antenna port 402a or the second antenna port 402b via the antenna switch 404.

The first bandpass filter 408a is configured to pass signals having the first downlink carrier frequency fRX1 from the second antenna port 402b to the third preamplifier 415 and reject frequency content outside of a passband around the first downlink carrier frequency fRX1 (e.g., outside of B20 RX frequency band). For example, the first bandpass filter 408a may at least reject signals having the second downlink carrier frequency fRX2 (e.g., signals within B8 RX frequency band). The second bandpass filter 408b is configured to pass signals having the second downlink carrier frequency fRX2 from the second antenna port 402b to the fourth preamplifier 416 and reject frequency content outside of a passband around the second downlink carrier frequency fRX2 (e.g., outside of B8 RX frequency band). For example, the second bandpass filter 408b may at least reject signals having the first downlink frequency fRX1 e.g., signals within B20 RX frequency band). In the illustrated embodiment, the input port of the first bandpass filter 408a is connected to the input port of the second bandpass filter 408b to provide a single receiving port of the multiplexing unit 430 that is connected to the second antenna port 402b via the antenna switch 404. In some embodiments, the coupled connection between the first and second bandpass filters 408a, 408b is selectively connected to either the first antenna port 402a or the second antenna port 402b via the antenna switch 404.

In the illustrated embodiment, one of the first and second uplink carrier frequencies (fTX1 and fTX2) can be in LTE band 8 (or NR band 8) and the other in LTE band 20 (or NR band 20). Similarly, one of the first and second downlink carrier frequencies (fRX1 and fRX2) can be in LTE band 8 (or NR band 8) and the other in LTE band 20 (or NR band 20). In the front-end module 405 carrier aggregation for transmit and/or receive are simultaneously supported for B8 and B20 carrier frequencies used for carrier aggregation.

In some cases, due to the electrical connection between the multiplex ports of the first and the second duplexer 406, 407 the two duplexers load each other resulting in a reduction of out of band gamma (γ) for each duplexer, or reduction of the S11 scattering coefficient for frequencies outside of the passband of the corresponding frequency selective RF path (e.g., provided by a bandpass filter). The loading effect can also increase loss in the frequency selective RF paths (the first and second uplink and downlink paths provided by the first and second duplexers 406, 407) established by these duplexers. The higher loss in the first and second uplink RF paths reduces the power added efficiency of the uplink signal transmission. The higher loss in the first and second main downlink paths reduces the signal-to-noise ration of the signals delivered to the low noise amplification unit 412 and thereby the sensitivity of the receiver.

In the arrangement of the multiplexing unit 432 of the front-end module 405 each filter portion of the two duplexers 406, 407 is loaded by three other filter portions and also has to be designed to sufficiently reject interfering signal content from one or more of the loading filter portions. As just one example, the receive filter portion 406b of the first duplexer 406 is loaded by the transmit filter portion 406a of the first duplexer 406, the transmit filter portion 407a of the second duplexer 407, and the receive filter portion 407b of the second duplexer 407. Moreover, the receive filter portion 406b of the first duplexer 406 in the illustrated embodiment needs to sufficiently reject signals content outside of its passband (e.g., outside B20 RX frequency band) including signal within the passbands of the receive filter portion 407b and the transmit filter portion 406a (e.g., B20 TX, and B8 RX frequency bands).

In some examples, given significant power difference between the transmit and receive signals, the receive filter portion 406b of the first duplexer 406 may reject or attenuate at least the signals having the first carrier frequency fTX1 (e.g., signals within the B20 TX frequency band), e.g., by more than 50 dB, more than 60 dB, or larger values. Similarly, the receive filter portion 407b of the second duplexer 407 may reject or attenuate at least the signals having the second carrier frequency fTX2 (e.g., signals within the B8 TX frequency band), e.g., by more than 50 dB, more than 60 dB, or larger values. As such a number of RF resonators used in each receive filter portion of a duplexer should be large enough to sufficiently attenuate transmit signals outside the corresponding passband (e.g., by more than 50 dB, or more than 60 dB). In some cases, the relatively large number of resonators used to provide sufficient attenuation can further increase the loss for the frequency selective RF paths (in-band loss) that are established by the corresponding duplexer. In some cases, given that the transmit switch 410 provides signals having one of the carrier frequencies (fTX1 or fTX2) at a time, the receive filter portions 406b, 407b may not attenuate both signals in both transmit bands (e.g., B20 TX and B8TX).

In addition to reduced performance (e.g., due to degradation of PAE and receiver sensitivity), the cost, complexity, and size of the front-end module 405 may scale with number of individual duplexers used as well as the number of resonators employed in each duplexer.

FIG. 4C shows the loading loss for a duplexer or filter portion within the duplexer as function of the number of filters or filter portions that are connected to the multiplex port of the duplexer (labeled o as “#of additional filters”), for different values of out-of-band gamma for the individual filter portions added to the duplexer. Here the baseline insertion loss (0 dB) corresponds to the unloaded duplexer. As shown in the plot, the loading loss linearly increases as a function of the number of filters or filter portions connected to the multiplex port of the duplexer. Such behavior is caused, at least partially, by the fact that the out-of-band gamma of the added filter or filter portions is smaller than 1 (its impedance is not a perfect open), at the corresponding TX and RX carrier frequencies. In the example shown, when out-of-band gamma is equal to 0.9, the loading loss resulting from adding one filter portion to the duplexer is about 0.22 dB, and the loading loss resulting from adding two filter portions to the duplexer is about 0.45 dB.

In addition, as the out-of-band gamma (γ) increases, the loading loss of the duplexer (and the filter portions therein) increases. In the example shown, loading loss for a duplexer loaded with two additional filters (or filter portions) increases from about 0.18 dB to about 0.45 dB as the out-of-band decreases from 0.96 to 0.9.

In the front-end module 405, each of the first or second duplexers 406, 407 is connected to (and therefore loaded by) two other filter portions in the other duplexer. For example, the duplexer 406 is loaded by the filter portions 407a, 407b of the duplexer 407. As such based on the plot in FIG. 4C, when out-of-band gamma for each filter portions is 0.9, the loading loss (e.g., residual insertion loss due to loading effect) for the first or second duplexer 406, 407, is about 0.45 dB. It should be understood that since the baseline in FIG. 2C is the insertion loss of a single duplexer the loading effect of the filter portions within the duplexer on each other is not taken into account. In some of the front-end designs disclosed below, the multiplexers are configured such that each filter portion is loaded by no more than two other filter portions to reduce the in-band insertion loss.

### Front-End Modules: Multiplexer With Combined Paths

As described above, multiplexers used in mobile communication systems require high levels of attenuation at the contiguous operating frequency bands while maintaining low insertion loss for the operating carrier frequency band. This is to ensure low susceptibility to potential power leakage from nearby bands.

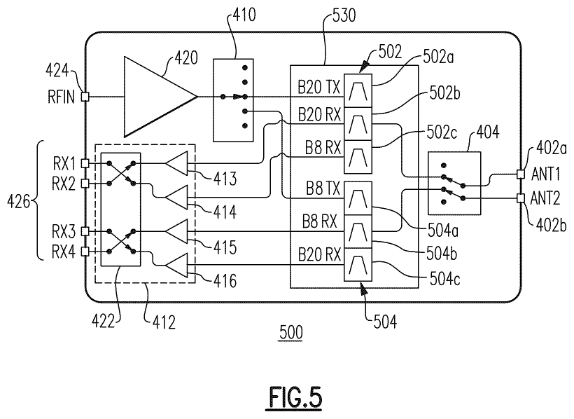

FIG. 5 is a schematic diagram of an example front-end module 500. Similar to front-end module 405, the preamplification unit 412 of the front-end module 500 comprises four preamplifiers 413, 414, 415, 416, and at least one output switch 422. The multiplexing unit 530 of the front-end module 500 comprises two triplexers 502, 504 configured to provide transmit RF paths from the carrier switch 410 to the a first antenna port 402a (via the antenna switch 404), main receive paths from the first antenna port 402a to two preamplifiers 413, 414, of the preamplifier unit 412, and diversity receive paths from the second antenna port 402b to the other two preamplifiers 415, 416, of the preamplifier unit 412, via the antenna switch 404. In some examples, each of the transmit paths, main receive paths, and diversity receive paths may comprise a frequency selective frequency selective RF path (also referred to as frequency selective path) that allows low loss RF transmission within a passband around a center frequency and rejects (e.g., strongly attenuates) signals having frequencies outside of the transmission bandwidth. The frequency selectivity of each path can be provided by a single filter portion (e.g., a bandpass filter) within one of the triplexers 502, 504. In some cases, the insertion loss for a frequency selective path can be dominated by the insertion loss of the corresponding filter portion.

A triplexer may include a first simplex port, a second simplex port, a third simplex port and a multiplex port. In some embodiments, the triplexer can include three ganged filters (or filter portions) that each provide a frequency selective TX or RX RF path between a corresponding simplex port and the multiplex port at frequencies within a particular passband around a frequency uplink carrier frequency (e.g., fTX1, fTX2) or around a downlink carrier frequency (e.g., fRX1, fRX2), where each of the ganged filter portions prevents signals having out of band frequencies from passing selective RF path (e.g., by strongly attenuating such signals). As such one the two ports of each filter portion can be electrically connected to a port of the other two filter portions to form the multiplex port of the triplexer, and the other port serves as a simplex port of the triplexer. In some embodiments, the three filter portions of a triplexer may be fabricated (e.g., monolithically) on a common substrate. In some such embodiments, the electrical interconnections between the filter portions may be provided by conductive lines fabricated on the common substrate. In some examples, the triplexer may comprise a package device having three simplex electrodes or pins serving as the three simplex ports of the triplexer and a multiplex electrode or pin serving as the multiplex port.

In the example shown, the first simplex port of the first triplexer 502 is connected to a first output port of the carrier switch 410, the second simplex port of the first triplexer 502 is connected to the input of the first preamplifier 413, the third simplex port of the first triplexer 502 is connected to the second preamplifier 414, and the multiplex port of the first triplexer 502 is selectively connected to the first antenna port 402a via the antenna switch 404. In some embodiments, the multiplex port can be selectively connected to either of the first antenna port 402a or the second antenna port 402b via the antenna switch 404.

In some embodiments, the first triplexer 502 includes three filter portions ganged together: a transmit filter portion 502a, a first receive filter portion 502b, and a second receive filter portion 502c. The transmit filter portion 502a provides a frequency selective RF path from the first output port of the carrier switch 410 to the antenna switch 404 within a passband around a first uplink carrier frequency fTX1 (e.g., within B20 TX frequency band). The first receive filter portion 502b provides a frequency selective RF path from the antenna switch 404 to the first preamplifier 413 within a passband around a first downlink carrier frequency fRX1 (e.g., within B20 RX frequency band). The second receive filter portion 502c provides a frequency selective RF path from the antenna switch 404 to the second preamplifier 414 within a passband around a second downlink carrier frequency fRX2 (e.g., within B8 RX frequency band).

Each of the three ganged filter portions 502a, 502b, 502c of the first triplexer 502 are configured to reject frequency content outside of the passband of the respective filter portion. In one embodiments, the transmit filter portion 502a of the first triplexer 502 may pass signals (or frequencies), e.g., received from carrier switch 410, within a passband around a first uplink carrier frequency fTX1 (e.g., within B20 TX frequency band) from its first simplex port to the antenna switch 404 and reject content outside its passband (e.g., outside B20 TX frequency band or a band therein). In some examples, the transmit filter portion 502a of the first triplexer 502 may reject at least frequency content within the passbands of the other ganged filter portions 502b, 502c (e.g., within B20 RX and B8 RX frequency bands or bands therein).

The first receive filter portion 502b of the first triplexer 502 may pass signals (or frequencies) (e.g., received from antenna switch 404) within a passband around a first downlink carrier frequency fRX1 (e.g., within B20 RX frequency band) from its multiplex port to its second simplex port and reject frequency content outside the passband (e.g., outside B20 RX frequency band or a band therein). In some examples, the first receive filter portion 502b of the first triplexer 502 may reject at least frequency content within the passbands of the other ganged filter portions 502a, 502c (e.g., B20 TX and B8 RX frequency bands or bands therein).

Similarly, the second receive filter portion 502c of the first triplexer 502 may pass signals (or frequencies) within a passband around a second downlink frequency fRX2 (e.g., within B8 RX frequency band) from its multiplex port to its third simplex port and reject signal content outside the passband (e.g., outside B8 RX frequency band or a band therein). In some examples, the second receive filter portion 502c of the first triplexer 502 may reject at least frequency content within the passbands of the other ganged filter portions 502a, 502b (e.g., B20 TX and B20 RX frequency bands or bands therein).

The first simplex port of the second triplexer 504 is connected to a second output port of the Carrier switch 410, the second simplex port of the second triplexer 504 is connected to the input of the third preamplifier 415, the third simplex port of the second triplexer 504 is connected to the fourth preamplifier 416, and the multiplex port of the second triplexer 504 is connected to the first antenna port 402a via the antenna switch 404.

The second triplexer 504 includes three filters ganged together: a transmit filter portion 504a, a first receive filter portion 504b, and a second receive filter portion 504c. The transmit filter portion is configured to provide a frequency selective RF path from the second output port of the carrier switch 410 to the antenna switch 404 within a passband around a second uplink carrier frequency fTX2 (e.g., within B8 TX frequency band). The first receive filter portion 504a provides a frequency selective RF path from the antenna switch 404 to the third preamplifier 415, within a passband around the second downlink carrier frequency fRX2 (e.g., within B8 RX frequency band). The second receive filter portion 504b provides a frequency selective RF path from the antenna switch 404 to the fourth preamplifier 416 within a passband around the first downlink carrier frequency fRX1 (e.g., within B20 RX frequency band).

Each of the three ganged filter portions 50a, 504b, 504c of the second triplexer 504 are configured to reject content outside of the passband of the respective filter portion. For example, the transmit filter portion 504a of the second triplexer 504 may pass signal or frequency content within a passband around the second uplink carrier frequency (e.g., within B8 TX frequency band) from its first simplex port to the antenna switch 404 and reject signal content outside the passband (e.g., outside B8 TX frequency band or a band therein). In some examples, the transmit filter portion 504a of the second triplexer 504 may reject at least frequency content within the passbands of the other ganged filter portions 504b, 504c (e.g., B8 RX and B20 RX frequency bands or bands therein).

The first receive filter portion 504b of the second triplexer 504 may pass signal or frequency content within a passband around the second downlink carrier frequency fRX2 (e.g., within B8 RX frequency band) from its multiplex port to its second simplex port and reject signal content outside the passband (e.g., outside B8 RX frequency band or a band therein). In some examples, the first receive filter portion 504b of the second triplexer 504 may reject at least frequency content within the passbands of the other ganged filter portions (e.g., B20 RX and B8 TX frequency bands or bands therein).

Similarly, the second receive filter portion 504c of the second triplexer 504 may pass signal or frequency content within a passband around the first downlink carrier frequency fRX1 (e.g., within B20 RX frequency band) from its multiplex port to its third simplex port and reject signal content outside of the passband (e.g., B20 RX frequency band). In some examples, the second receive filter portion 504c of the second triplexer 504 may reject at least frequency content within the passbands of the other ganged filter portions 504a, 504b (e.g., B8 TX and B8 RX frequency bands or bands therein).

As described above, in various embodiments, the first uplink and downlink carrier frequencies (fTX1 and fRX1) and, the second uplink and downlink carrier frequencies (fRX1 and fRX2) can comprise any four carrier frequencies that may be used for down link and uplink carrier aggregation. In some embodiment, the B20 and B8 frequency bands can be used carrier aggregated uplink and downlink wireless communication. In such embodiments, fTX1, fTX2, fRX1, and fRX2 can be B20 TX, B8 TX, B20 RX and B8 RX respectively. In various implementations the B20 and B8 may be associated with LTE or NR wireless technologies. In some embodiments, other pair of frequency bands may be used for carrier aggregation. For example, B5 and B12 frequency bands, B5 and B13 frequency bands, B5 and B28 frequency bands, B8 and B28 frequency bands, B20 and B28 frequency bands can be used carrier aggregated uplink and downlink wireless communication. As such, fTX1 can be B5 TX, B8 TX, or B28 TX; fTX2 can be B12 TX, B13 TX, or B28 TX; fRX1 can be B5 RX, B8 RX, or B28 RX; and fRX2 can be B5 RX, B8 RX, or B28 RX.

Some examples of possible operating modes of the front-end module 500 will now be described.

In a first operating mode, the front-end module 500 is configured to transmit on the B20 TX path of the first triplexer 502 and implement DL-CA to aggregate the following four simultaneous receive DL sub-channels: B20 RX and B8 RX through the first triplexer 502 and B8 RX and B20 RX through the second triplexer 504. In such a configuration, the active three paths running through the first triplexer 502 can be referred to as the “primary” paths, and the two receive paths running through the second triplexer 504 can be referred to as the “diversity” paths.

In a second operating mode, the front-end module 500 is configured to transmit on the B8 TX path of the second triplexer 504 and implement DL-CA to aggregate the following four simultaneous receive DL sub-channels: B8 RX and B20 RX through the second triplexer 504 and B20 RX and B8 RX through the first triplexer 502. In such a configuration, the active three paths running through the second triplexer 504 can be referred to as the “primary” paths, and the two receive paths running through the first triplexer 502 can be referred to as the “diversity” paths.

The embodiment of FIG. 5 is different from the embodiment of FIG. 4B in that the filter portions 502a-c, 504a-c of the triplexers 502, 504 are connected to and loaded by only two filter portions within the respective triplexer that are ganged together. In contrast, in the embodiment of FIG. 4B, the transmit filter portions of the duplexers 406, 407 are connected to and loaded by three filter portions including the receive filter portion of that duplexer and also the transmit and receive filters of the other duplexer. Due to the reduced loading, transmit performance (e.g., PAE) can be improved for the embodiment of FIG. 5 as compared to the embodiment of FIG. 4B.

Moreover, the receive filter portions 502b, 502c of the first triplexer 502 are only directly connected to one transmit path, B20 TX, and the receive filter portions 504b, 504c of the second triplexer 504 are similarly only directly connected to one transmit path, B8 TX. Thus, the receive filter portions 502b, 502c of the first triplexer 502 can have relaxed rejection requirements for B8 TX and the receive filter portions 504b, 504c of the second triplexer 504 can have relaxed rejection performance requirements for B20 TX. In contrast, for the embodiment of FIG. 4B, the receive filter portions 406b, 407b of the first and second duplexers 406, 407 are ganged with the respective transmit filter portions 406a, 407a and thereby should reject the transmit signals within the B20 TX and B8 TX frequency bands, respectively. Thus, the rejection performance required of the receive filter portions of the first and second duplexers 406, 407 of FIG. 4B are higher than those of the triplexers 502, 504 of FIG. 5.

In some embodiments, a frequency selective RF path provided by the first or the second triplexer 502, 504 can have a insertion loss less than 0.5 dB, less than 1 dB, less 2 dB, or less than 3 dB. The first and the third triplexers 502, 504 may prevent the transmission of a signal via the frequency selective RF path by attenuating the signal (e.g., by 30 dB to 40dB, 40 dB to 50 dB, 50 dB to 60 dB, or greater values).

In some embodiments the first or the third triplexer 502, 504, each may comprise three bandpass filters disposed between the multiplex port and the three simplex ports. In some such embodiments, an interconnection (e.g., an RF power divider/combiner) may provide RF connection between the multiplex port and each bandpass filter. In some cases, an individual bandpass filter may have a frequency transfer function comprising a center frequency and a passband around the center frequency. In some examples, the width of the passband of the passband filters can be about 20 MHz, about 30 MHZ, about 35 MHz, about 40 MHz, about 50 MHz, about 100 MHz, or any value between any of the foregoing values.

For example, B8 TX has a passband of about 35 MHz, B8 RX has a passband of about 35 MHz, B20 TX has passband of about 30 MHz, and B20 RX has passband of about 30 MHz.

The bandwidth and the center frequency of a bandpass filter within a triplexer (e.g., the first or the third triplexer 502, 504) may be selected based on a desired data rate and a carrier frequency transmitted via the bandpass filter. Similarly, the bandwidth and the center frequency of a frequency selective RF path within a triplexer may be selected based on a desired data rate and a carrier frequency transmitted via the frequency selective RF path.

In some cases, a bandpass filter or frequency selective RF path within a triplexer (e.g., the first or the third triplexer 502, 504) can isolate two signals having different carrier frequencies by more than 30 dB, more than 40 dB, more than 50 dB, more than 60 dB or greater values.

As described above with respect to FIG. 4C, loading a multiplexer by another filter portion that has an out of band gamma less than unity (does not behave as an open end for signal having frequencies outside of its passband), can increase the insertion loss of the loaded multiplexer. Unlike the duplexers 406, 407, of the multiplexing unit 432, the triplexers 502, 504 of the multiplexing unit 530 of the front-end module 500 are not electrically connected (e.g., they do not share any port) and therefore do not load each other. As mentioned above, each filter portion of the triplexers 502, 504 is loaded by two other filter portions. To compare the insertion loss of the triplexers 502, 504 with the insertion loss of the duplexers 406, 407, one can use the data in FIG. 2C taking the insertion loss of a combined pair filter portion (equivalent to a duplexer) as the base line. For example, the filter portions 502a and 502b may be considered as a duplexer loaded by one additional filter portion 502c. Assuming out-of-band gamma is 0.9 for each filter portion, the loading loss for the triplexer 502 is about 0.22 dB (with respect to an isolated duplexer). As such the loading loss for the triplexer 502 (or 504) is more than 0.2 dB less than the loading loss of the duplexer 406 (or 407) in the front-end module 405 (that is about 0.45 for an out-of-band gamma 0 f 0.9). As a result, the insertion loss for each one of the frequency selective RF paths provided by the triplexers 502, 504 can be less than the insertion loss of the respective frequency selective RF paths provided by the duplexers 406, 407. A lower insertion loss in a receive path can result in a greater signal-to-noise ratio (SNR) and thereby better sensitivity of a receiver that uses the front-end module 500 instead of the front-end module 405. A lower insertion loss in a transmit path can result in a greater power added efficiency (PAE) for a transmitter that uses the front-end module 500 instead of the front-end 405.

As described above (and shown in FIG. 5) each triplexer of the front-end module 500 is electrically connected to a different antenna port and therefore different antenna. In some cases, an RF isolation between the first antenna port 402a and the second antenna port 402b can be greater than 10 dB, greater than 15 dB, greater than 20 dB, or greater values. As such an RF isolation between the multiplex port of the first triplexers 502 and the multiplex port of the second triplexer 504 can be isolated be also greater than 10 dB, greater than 15 dB, greater than 20 dB, or greater values. In some cases, the isolation between the multiplex ports of the first triplexer 502 and the multiplex port of the second triplexer 504 may relax the level signal rejection provided by different receive frequency selective RF paths or (e.g., receive filter portions 502b, 502c, 504b, 504c) within each triplexer because cross talk between RF paths in different triplexers is attenuated due to antenna port isolation and receive frequency selective paths within each multiplexer primarily reject transmit signals within a single transmit passband (e.g., B20 TX or B8 TX) ( ) For example, when the antenna ports 402a, 402b are isolated by 15 dB, the rejection of transmit signals having the second transmit carrier frequency fTX2 (e.g., signals within B8 TX frequency band) by the receive filter portions 502b, 502c of the first triplexer 502 that support B8 RX and B20 RX can be relaxed (e.g., from 60 dB to 50 dB, to 45 dB, or to lower values). As another example, when the antenna ports 402a, 402b are isolated by 15 dB, the rejection transmit signals having the first uplink carrier frequency fTX1 (e.g., signals within B20TX frequency band) by the receive filter portions 504b, 504c, of the second triplexer 504 that support B8 RX and B20 RX can be relaxed (e.g., from 60 dB to 50 dB, to 45 dB, or to lower values).

When a lower level of isolation is required for an RF path or filter, a number RF resonators in the corresponding RF path or filter portion (e.g., receive filter portions 502b, 502c, 504b, 504c) can be reduced compared to a case where two duplexer or triplexer share an antenna port (e.g., compared to the level isolation provide by the receive filter portions 406b and 407b in front-end module 405), without degrading the sensitivity (e.g., in the case of a receive path). Advantageously, reducing the number of RF resonators in a filer or RF path can reduced RF loss through the filter or RF path and improve thereby improve the sensitivity of the receiver and the PAE of the transmitter implemented based on the front-end module 500.

One should appreciate that in contrast to the triplexers 502, 504 in the multiplexing unit 530 of the front-end module 500, the duplexers 406, 407 in the multiplexing unit 432 of the front-end module 405 are connected to a the same antenna port (first antenna port 402a) and therefore each low RF path provided by a duplexer should be isolated from signals having any one the three other carrier frequencies (one associated with the other path in the same duplexer and the other two associated with the other duplexer). As such, the front-end module 500 can provide better sensitivity (in the receiving mode) and better PAE (particularly in the transmit mode) compared to front-end module 405 or other front-end designs that include multiplexers electrically connected to the same antenna port. Additionally, a reduction of number of resonators in the triplexers enables implementation of the front-end module 500 based on more compact triplexers and reduces the cost in large scale productions (as smaller number of resonators in each triplexer can noticeably reduce the fabrication and material cost over large number of triplexers produced). So, compared to the front-end module 405, the front-end module 500 not only provides better sensitivity and PAE (due to absence of loading effect and implementation based on a smaller number of RF resonators), but also enables fabricating more compact front-end modules at a lower cost.

### Applications, Terminology, and Conclusion

Any of the embodiments described above can be implemented in association with mobile devices such as cellular handsets. The principles and advantages of the embodiments can be used for any systems or apparatus, such as any uplink wireless communication device, that could benefit from any of the embodiments described herein. The teachings herein are applicable to a variety of systems. Although this disclosure includes example embodiments, the teachings described herein can be applied to a variety of structures. Any of the principles and advantages discussed herein can be implemented in association with RF circuits configured to process signals having a frequency in a range from about 30 kHz to 300 GHz, such as in a frequency range from about 450 MHz to 8.5 GHz. Tunable filters disclosed herein can filter RF signals at frequencies up to and including millimeter wave frequencies, for example, frequencies within FR2 of a 5G NR specification.

Aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only and are not intended to limit the scope of the disclosure. Indeed, the novel filters, wireless communication devices, apparatus, methods, and systems described herein may be embodied in a variety of other forms. Furthermore, various omissions, substitutions and changes in the form of the filters, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio frequency front-end configured for carrier aggregated wireless communication, the radio frequency front-end comprising:
a first multiplexer having at least first, second, and third filters, the first filter having a passband of an uplink channel of a first band, the second filter having a passband of a downlink channel of the first band, and the third filter having a passband of a downlink channel of a second band; and
a second multiplexer having at least fourth, fifth, and sixth filters, the fourth filter having a passband of an uplink channel of the second band, the fifth filter having a passband of the downlink channel of the second band, and the sixth filter having a passband of the downlink channel of the first band; and
an antenna switch connected to a first multiplexed port of the first multiplexer and a second multiplexed port of the second multiplexer to selectively connect the first multiplexed port to at least a first antenna and selectively connect the second multiplexed port to at least a second antenna.

2. The radio frequency front-end of claim 1 wherein a radio frequency isolation between the first and second antennas is larger than 15 dB for the first and second bands.

3. The radio frequency front-end of claim 1 wherein the first, second, and third filters are configured to attenuate frequencies outside of their respective passbands by at least 40 dB.

4. The radio frequency front-end of claim 3 wherein at least one of the first, second, and third filters is configured to attenuate frequencies outside of its respective passband by less than 50 dB.

5. The radio frequency front-end of claim 1 wherein the fourth, fifth, and sixth filters are configured to attenuate frequencies outside of their respective passbands by at least 40 dB.

6. The radio frequency front-end of claim 5 wherein at least one of the fourth, fifth, and sixth filters is configured to attenuate frequencies outside of its respective passband by less than 50 dB.

7. The radio frequency front-end of claim 1 wherein the first band is LTE band 20 and the second band is LTE band 8 (B8).

8. The radio frequency front-end of claim 1 wherein the first multiplexed port includes a connection between an output of the first filter, an input to the second, and an input to the third filter, and the second multiplexed port includes a connection between an output of the fourth filter, an input to the fifth filter, and an input to the sixth filter.

9. The radio frequency front-end of claim 8 wherein the first, second, and third filters are ganged together on a common substrate, and the fourth, fifth, and sixth filters are ganged together on a common substrate.

10. The radio frequency front-end of claim 1 further comprising a transmit power amplifier and a band select switch configured to selectively connect an output of the transmit power amplifier to either of the first filter or the fourth filter.

11. The radio frequency front-end of claim 1 further comprising first, second, third and fourth receive amplifiers, inputs of the first, second, third, and fourth receive amplifiers respectively connected to outputs of the second, third, fifth, and sixth filters.

12. The radio frequency front-end of claim 1 wherein the front-end is configured to implement downlink carrier aggregation using four downlink signals output by the second, third, fifth, and sixth filters.

13. A mobile device comprising:
at least first and second antennas;
a first multiplexer having at least first, second, and third filters, the first filter having a passband of an uplink channel of a first band, the second filter having a passband of a downlink channel of the first band, and the third filter having a passband of a downlink channel of a second band;
a second multiplexer having at least fourth, fifth, and sixth filters, the fourth filter having a passband of an uplink channel of the second band, the fifth filter having a passband of the downlink channel of the second band, and the sixth filter having a passband of the downlink channel of the first band; and
an antenna switch connected to a first multiplexed port of the first multiplexer and a second multiplexed port of the second multiplexer to selectively connect the first multiplexed port to at least the first antenna and selectively connect the second multiplexed port to at least the second antenna.

14. The mobile device of claim 13 wherein the first, second, and third filters are ganged together on a common substrate, and the fourth, fifth, and sixth filters are ganged together on a common substrate.

15. The mobile device of claim 13 wherein a radio frequency isolation between the first and second antennas is larger than 15 dB for the first and second bands.

16. The mobile device of claim 15 wherein at least one of the first, second, and third filters is configured to attenuate frequencies outside of its respective passband by less than 50 dB.

17. The mobile device of claim 13 wherein the fourth, fifth, and sixth filters are configured to attenuate frequencies outside of their respective passbands by at least 40 dB.

18. The mobile device of claim 17 wherein at least one of the fourth, fifth, and sixth filters is configured to attenuate frequencies outside of their respective passbands by less than 50 dB.

19. The mobile device of claim 13 wherein the first multiplexed port includes a connection between an output of the first filter, an input to the second, and an input to the third filter, and the second multiplexed port includes a connection between an output of the fourth filter, an input to the fifth filter, and an input to the sixth filter.

20. A frequency multiplexing device configured for carrier aggregated wireless communication, the frequency multiplexing device comprising:
a first multiplexer including at least first, second, and third filters, the first filter having a passband of an uplink channel of a first band, the second filter having a passband of a downlink channel of the first band, and the third filter having a passband of a downlink channel of a second band, the first multiplexer further including a first multiplexed port having a connection between an output of the first filter, an input to the second filter, and an input to the third filter; and
a second multiplexer including at least fourth, fifth, and sixth filters, the fourth filter having a passband of an uplink channel of the second band, the fifth filter having a passband of the downlink channel of the second band, and the sixth filter having a passband of the downlink channel of the first band, the second multiplexer further including a second multiplexed port having a connection between an output of the fourth filter, an input to the fifth filter, and an input to the sixth filter.
